(19) United States
(12) Patent Application Publication
(10) Pub. No.: US 2007/0153828 A1
(43) Pub. Date: Jul. 5, 2007

(54) System and method to negotiate the addition or deletion of a PPP link without data loss

(75) Inventors: Kirankumar Vishnubhatla, San Jose, CA (US); Sonali M. Sambhus, Milpitas, CA (US); Mui Anne Chang, Foster City, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Cisco Technology, Inc.

(21) Appl. No.: 11/326,361

(22) Filed: Jan. 4, 2006

(51) Int. Cl. H04J 3/22; H04J 3/16; H04J 1/16

(52) U.S. Cl. 370/468; 370/252

(57) ABSTRACT

A method and apparatus for managing point-to-point protocol (PPP) links between a first endpoint and a second endpoint. The method may, when opening a link, receive an acknowledgement at the first endpoint from the second endpoint, open the receive portion of the link at the first endpoint, send a response acknowledgement from the first endpoint to the second endpoint, and delay transmission of data from the first endpoint to the second endpoint for a selected time period after the response acknowledgement. The method may further, when closing the link, close the transmit portion of the link at the first endpoint and send a terminate request to the second endpoint, then receive a terminate acknowledgement from the second endpoint to indicate the second endpoint transmit portion of the link is closed, and close the receive portion of the link at the first endpoint after the receipt of the terminate acknowledgement.

### TECHNICAL FIELD

The present invention relates generally to networks and more particularly to the negotiation of the addition or deletion of one or more PPP links without data loss.

### BACKGROUND

In PPP (point to point protocol) communications, both the sending and receiving devices negotiate or provision a connection/link by sending out LCP (link control protocol) packets to determine specific information that will be required for data transmission. The LCP checks the identity of the linked device and either accepts or rejects the peer device, determines the acceptable packet size for transmission, searches for errors in configuration, and can terminate the link if the parameters are not satisfied. Data cannot be transmitted over the network until the LCP packet determines that the link is acceptable. However, even in cases where the LCP packet determines the link is acceptable, data loss may occur, particularly in a multi-link PPP (MLPPP) scenario.

For example, service providers prefer to lease T1/E1 lines as needed in response to increases in network traffic. MLPPP may be used to address this requirement. In most PPP systems, the control protocols are implemented on the host processor and hardware is programmed according to the current protocol states. Control PPP packets and data packets are processed at different rates because the PPP state machine handling the control PPP packets is implemented in software while the data packets are processed by the hardware. This architecture along with the current definition of PPP & MLPPP standards provides a potential for data loss during a PPP link provisioning to a MLPP bundle. In systems with high reliability requirements, it is not desirable to disrupt the normal data traffic flow while links are being provisioned on the multi link bundle.

### BRIEF DESCRIPTION OF THE DRAWINGS

The present invention is illustrated by way of example, and not by way of limitation, in the figures of the accompanying drawings in which:

FIG. 1 illustrates an embodiment of a PPP (point to point protocol) system that may be configured to provision PPP communication links between one or more devices without data loss;

FIG. 2A is a timing diagram illustrating an embodiment of a first end device and a second end device provisioning the addition of a new PPP link;

FIG. 2B is a timing diagram illustrating an embodiment of a first end device and a second end device provisioning the deletion of an existing PPP link;

FIG. 3A is a flow chart illustrating operations for adding the PPP link to the MLPPP bundle, according to one embodiment of the invention;

FIG. 3B is a flow chart illustrating operations for deleting the PPP link from the MLPPP bundle, according to one embodiment of the invention; and

FIG. 4 is a diagrammatic representation of a machine in the example form of a computer system within which a set of instructions may be executed to cause the machine to perform any one or more of the methodologies discussed herein.

### DETAILED DESCRIPTION

In the following description, for purposes of explanation, numerous specific details are set forth in order to provide a thorough understanding of one or more embodiments of the present invention. It will be evident, however, to one skilled in the art that the present invention may be practiced without these specific details. In various embodiments, a potential advantage may be to eliminate data loss when a PPP link is added or deleted from a PPP bundle.

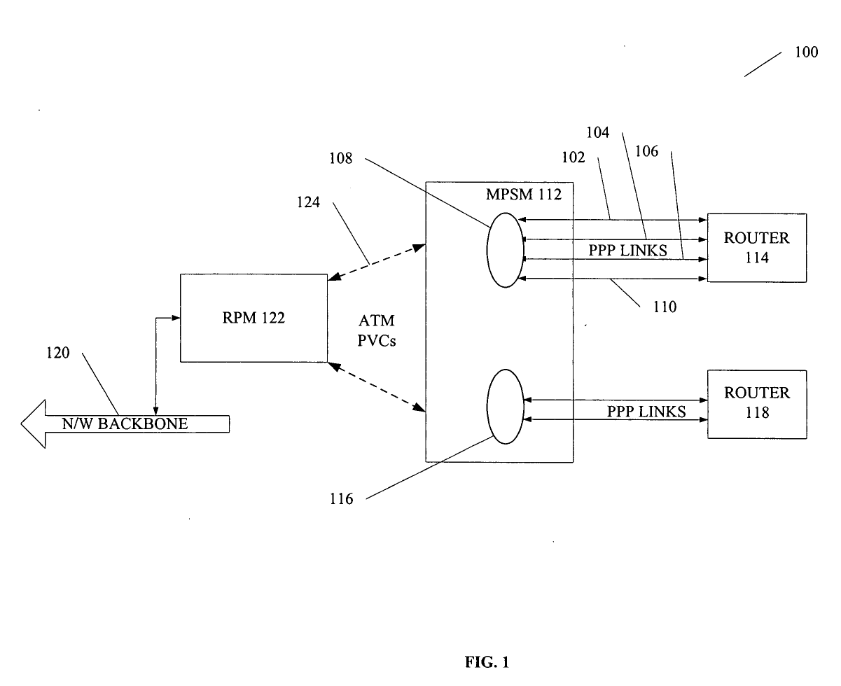

FIG. 1 illustrates an embodiment of a PPP (point to point protocol) system 100 that may be configured to provision PPP communication links between one or more devices without data loss. In one embodiment, there are multiple links bundled together forming an MLPPP (multi-link PPP) bundle. MLPPP allows multiple PPP links to be combined into a bundle creating a virtual link with an aggregate bandwidth that is greater than each of the individual links. For example, link 102, link 104 and link 106 make up MLPPP bundle 108. In one embodiment, it may be desirable to add a PPP link 110 between two end points corresponding to two network devices, such as a MPSM (multi-protocol service module) 112 and a router 114, to increase aggregate bandwidth. In another embodiment, it may be desirable to remove the PPP link 110 as system requirements change, such as bandwidth demand by the router 114.

The MPSM 112 provides transport functionality in the aggregation network. For example, the MPSM 112 may provide MLPPP protocol processing, PPP multiplexing and demultiplexing, interworking between PPP and PPPoATM (asynchronous transfer mode) devices, and buffering and prioritization of network traffic from a router process module (RPM) 122 to the router 114.

In one embodiment, adding the PPP link 110 begins with a negotiating process between the MPSM 112 and the router 114, according to PPP provisioning standards (e.g., configuration request (CR) and acknowledge (ACK)). Data loss may be prevented during the provisioning or adding of a link by transitioning (e.g., open and/or close) the transmit and the receive states at different periods of time, as further discussed below.

In another embodiment, deleting a link, such as the PPP link 110, begins with a similar negotiating process discussed above except it begins with a termination request (TR) between the MPSM 112 and the router 114. Data loss may also be prevented during deleting a link by transitioning the transmit and the receive state (e.g., open and/or close) at different periods of time, as further discussed below.

It can be appreciated by those skilled in the art that in various embodiments, PPP links and MLPPP bundles, are not limited to devices such as the MPSM 112 and the router 114, but may also include other PPP devices, such as network switches, gateways, routers, personal computers, etc. In one embodiment, the MPSM 112 may include additional bundles (e.g., MLPPP bundle 116) coupled to other routers (e.g., router 118).

In one embodiment, the MPSM 112 receives/sends and processes data packets destined to or from router 114 through MLPPP bundle 108. The data may be from network backbone 120, processed by the RPM 122, and sent on to MPSM 112 en route for a destination beyond router 114. In one embodiment, the coupling between the RPM 122 and MPSM 112 is a private virtual channel (PVC) sending encapsulated packets such as PPPoATM (PPPo asynchronous transfer mode) packets, and the network backbone 120 is an IP (internet protocol) network.

The RPM 122 may serve as an edge router feeding into a core router (not shown) on network backbone 120. One of its functions may be to aggregate traffic from routers (e.g., router 114) to put onto the network backbone 120. Other functions may be to terminate multiple PPPoATM links and NCP (network control program) sessions, compression and decompression of UDP/IP (user datagram protocol/internet protocol) packet headers, and enforce quality of service (QoS) policies on traffic outbound to routers (e.g., router 114).

With every MLPPP bundle (e.g., MLPPP bundle 108), there is an associated PVC link (e.g., multi-protocol (MP) bundle 124) between the MPSM 112 and the RPM 122. The PVC is used for transporting the traffic from the MSPM 112 on the MP bundle 124 to the RPM 122. In varying embodiments, the PVC bandwidth may need to be increased in response to adding the PPP link 110 and the PVC bandwidth may need to be reduced in response to removing or terminating the PPP link 110.

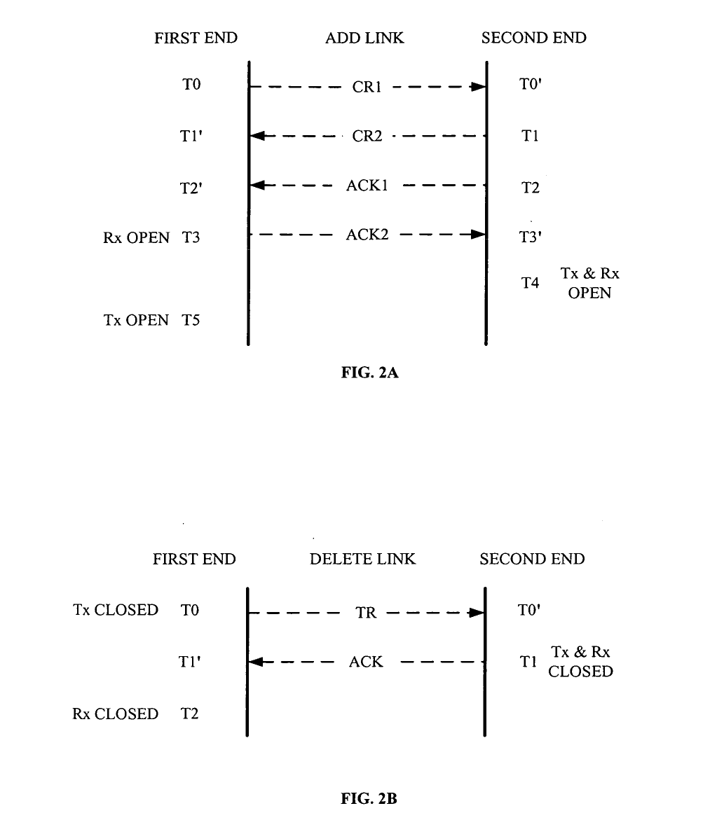

FIG. 2A is a timing diagram illustrating an embodiment of a first end device (e.g., MPSM 112) and a second end device (e.g., router 114) provisioning the addition of a new PPP link (e.g., PPP link 110). In one embodiment, this may be accomplished by automatically changing transmit and receive states (e.g., open and/or closed) of the first end device and the second end device at different periods of time.

At T0, a configuration request (CR1) is sent from the first end device to the second end device requesting an addition of the new link. In one embodiment, the addition of the new link is to an existing bundle of links previously established between the first end device and the second end device. The received CR1 is processed by the second end device and responds with a return configuration request (CR2) at T1 and an acknowledgement (ACK1) at T2. At T3, the first end device responds with a return acknowledgement (ACK2) and transitions the first end device receive state to open, thereafter all data received at the first end device may be processed. However, at T3 the transmit state remains closed since the second end device cannot yet receive and process data. It should be noted, T1′, T2′, and T3′ are T1, T2, and T3, respectively, plus a transmission delay between the first end device and the second end.

At T4, the second end device processes ACK2 received from the first end device and transitions the second end device PPP link state to open. In one embodiment, transitioning the link state to open includes transitioning the transmit and receive state to open. In another embodiment, only the receive state is transitioned to open and the transmit state may be opened anytime thereafter. At T5, the first end device transitions its transmit state to open, wherein T5 is a time greater than the sum of the transmission delay associated with the sending and receiving of ACK2, and the delay associated with processing the ACK2 and transitioning the second end device receive state (and optionally transmit state) to open. In other words, the difference between T5 and T3 should be greater than the sum of these delays. When this condition is met, data loss is avoided since the first end device will not transmit data until the second end device is ready to receive the data.

FIG. 2B is a timing diagram illustrating an embodiment of a first end device (e.g., MPSM 112) and a second end device (e.g., router 114) provisioning the deletion of an existing PPP link (e.g., PPP link 110). In one embodiment, this may be accomplished by automatically changing transmit and receive states (e.g., open and/or closed) of the first end device and the second end device at different periods of time.

In contrast to adding a PPP link, deleting a link does not require a configuration request (CR) since the PPP link had previously been established between the first end device and the second end device. In this case, at T0 the first end device sends terminate request (TR) to the second end device and transitions the transmit state to closed while leaving the receive state open. At T1, the second end device processes the TR, sends an acknowledgment (ACK) to the first end, and transitions the transmit and receive state to closed. Transitioning the receive state to closed at the second end device does not result in data loss since the first end device had previously ceased transmission. Leaving the receive state open at the first end device (at T0) allows the first end device to process data from the second end device during the delay between the TR sent by the first end device and the transition of the transmit state to closed at the second end device.

At T2, the first end device processes the ACK from the second end device and transitions the receive state to closed. Since the second end device stopped transmission of data at T1, no data is lost when the first end device closes the receive state at T2.

Therefore, by enabling and disabling the transmission and receiving states at the first end device and the second end device at different time periods, data loss may be eliminated during the addition and deletion of PPP links, individually or from a multi-link PPP bundle.

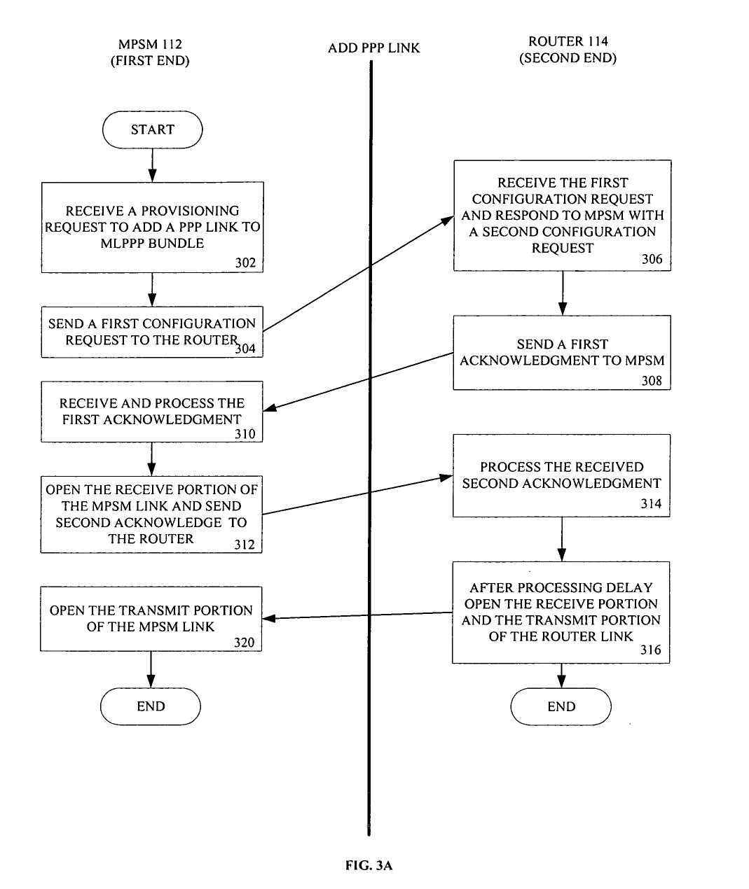

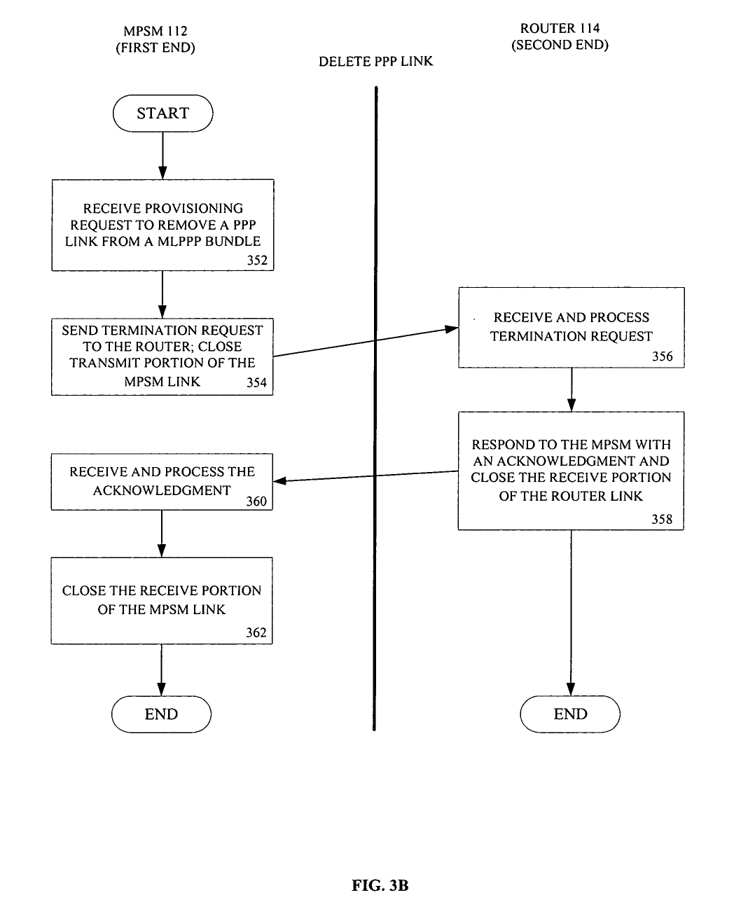

FIG. 3A is a flow chart illustrating operations for adding the PPP link 110 to the MLPPP bundle 108, according to one embodiment of the invention. The link negotiation begins at operation 302, where the MPSM 112 receives a provisioning request to add the PPP link 110 to the MLPPP bundle 108. In response, at operation 304, the MPSM 112 sends a first configuration request to the router 114. The router 114 receives the first configuration request and responds to MPSM 112 with a second configuration request (see operation 306). At operation 308, the router 114 sends a first acknowledgment to MPSM 112 and the MPSM 112 receives and processes the first acknowledgment at operation 310. After processing, the MPSM 112, at operation 312, opens its receive portion of the link and sends a second acknowledgment to the router 114. The router 114, at operation 314, processes the received second acknowledgment, and after a processing delay, the router 114, at operation 316, opens its receive portion and transmit portion of the link. Lastly, at operation 320, MPSM 112 opens its transmit portion of the link since the router 114 is now capable of receiving data.

FIG. 3B is a flow chart illustrating operations for deleting the PPP link 110 from the MLPPP bundle 108, according to one embodiment of the invention. The PPP link termination begins at operation 352 where the MPSM 112 receives a provisioning request to remove the PPP link 110 from the MLPPP bundle 108. The MPSM 112 at operation 354 sends termination request to the router 114, where the termination request is received and processed at operation 356. The router 114, at operation 358, responds to the MPSM 112 with an acknowledgment and opens its receive portion of the link and closes its transmit portion of the link and therefore no longer able to transmit or receive data. At operation 360, the MPSM 112 receives and processes the acknowledgment and, at operation 362, closes its receive portion of the link since it may no longer receive data from the router 114 on this PPP link.

As illustrated by the example embodiments discussed above, by enabling and disabling the transmission and receiving states at the MPSM 112 and the router 114 at different time periods, data loss may be substantially reduced (preferably eliminated) during the addition and deletion of PPP links, individually or from a multi-link PPP bundle.

Although the embodiments discussed above illustrate adding and deleting links in the link control protocol (LCP) layer of PPP, the methods discussed herein may be applied to embodiments including adding and deleting connections in the network control program (NCP) layer. Such as MUX (multiplexed) NCP, where a multitude of packets are multiplexed into a single frame. For example, data may be flowing in a non MUXed format and a multiplexer is added a first end device and then on a second end device. In order to avoid losing packets (data) because one end can take effect for MUXing packets before the other end, the methods described herein for enabling and disabling the transmission and receiving states at the first end device and the second end device at different time periods may be utilized.

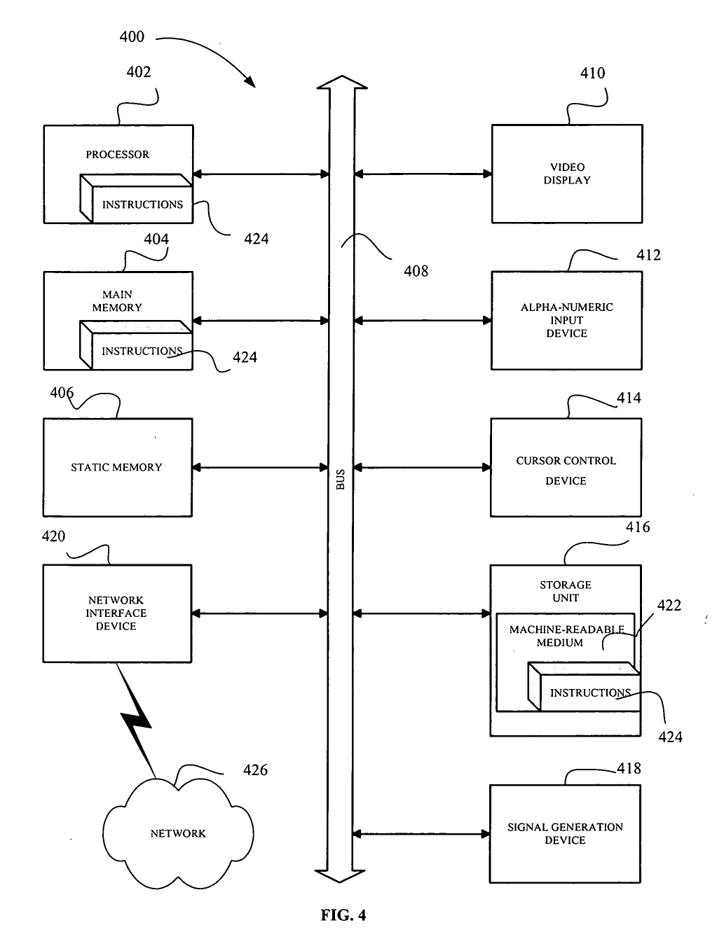

FIG. 4 illustrates a diagrammatic representation of machine in the exemplary form of a computer system 400 within which a set of instructions may be executed to cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment.

The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processor 402 (e.g., a central processing unit (CPU) a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a cursor control device 414 (e.g., a mouse), a storage unit 416 (e.g., hard-disk drive), a signal generation device 418 (e.g., a speaker) and a network interface device 420.

The storage unit 416 includes a machine-readable medium 422 on which is stored one or more sets of instructions (e.g., software 424) embodying any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media. The software 424 may further be transmitted or received over a network 426 via the network interface device 420.

While the machine-readable medium 422 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

We claim:

1. A method of managing point-to-point protocol (PPP) links between a first endpoint and a second endpoint, the method comprising:
opening a link by receiving an acknowledgement at the first endpoint from the second endpoint;
opening the receive portion of the link at the first endpoint;
sending a response acknowledgement from the first endpoint to the second endpoint; and
delaying transmission of data from the first endpoint to the second endpoint for a selected time period after the response acknowledgement has been sent.

2. The method of claim 1, which comprises, prior to receiving the acknowledgement at the first endpoint, establishing PPP connection parameters based on the second endpoint receiving a configuration request from the first endpoint, and the second endpoint responding with a response configuration request.

3. The method of claim 1, which comprises, during the selected time period, opening the receive portion and the transmit portion of the link at the second endpoint.

4. The method of claim 3, which comprises, after the selected time period, opening the transmit portion of the link at the first endpoint.

5. The method of claim 1, wherein the selected time period is determined by calculating the time difference based on at least one of the sum of the transmission delay on the link between the first endpoint and the second endpoint, a first delay associated with processing the response acknowledgment at the second endpoint, and a second delay associated with opening the receive portion of link at the second endpoint.

6. The method of claim 1, wherein the delaying transmission of data from the first endpoint to the second endpoint includes sending another acknowledgement after the elapsed selected time period to the first endpoint to indicate the transmit portion and receive portion of the link at second endpoint is open.

7. The method of claim 1, wherein the first endpoint and the second endpoint support multi-link PPP (MLPPP).

8. The method of claim 1, wherein the PPP link between the first endpoint and the second endpoint is a link control protocol (LCP) link.

9. The method of claim 1, wherein the PPP link between the first endpoint and the second endpoint is a multiplexed network control program (NCPMUX) link.

10. A method of managing point-to-point protocol (PPP) links between a first endpoint and a second endpoint, the method comprising:
closing a link by closing the transmit portion of the link at the first endpoint and sending a terminate request to the second endpoint;
receiving a terminate acknowledgement from the second endpoint to indicate the second endpoint transmit portion of the link is closed; and
closing the receive portion of the link at the first endpoint after the receipt of the terminate acknowledgement.

11. The method of claim 10, which comprises, after the receiving of the terminate acknowledgement from the second endpoint, closing the receive portion of the link at the second endpoint.

12. The method of claim 10, wherein the first endpoint and the second endpoint support multi-link PPP (MLPPP).

13. The method of claim 10, wherein the PPP link between the first endpoint and the second endpoint is a link control protocol (LCP) link.

14. The method of claim 10, wherein the PPP link between the first endpoint and the second endpoint is a multiplexed network control program (NCPMUX) link.

15. An apparatus to manage point-to-point protocol (PPP) links between a MPSM (multi-protocol service module) and a PPP device, the apparatus comprising the MPSM when opening a link to:
receive an acknowledgement from the PPP device;
open a receive portion of the link at the MPSM;
send a response acknowledgement to the PPP device; and
to delay transmission of data from the MPSM to the PPP device for a selected time period after the response acknowledgement has been sent.

16. The apparatus of claim 15, wherein prior to the reception of the acknowledgement from the PPP device, the MPSM to establish PPP connection parameters based on a configuration request received at the PPP device from the MPSM and a response configuration request received at the MPSM from the PPP device.

17. The apparatus of claim 15, wherein within the selected time period, the PPP device to open its receive portion and its transmit portion of the link.

18. The apparatus of claim 17, wherein after the selected time period, the MPSM to open its transmit portion of the link.

19. The apparatus of claim 15, wherein the MPSM to calculate the selected time period based on at least one of the sum of the transmission delay on the link between the MPSM and the PPP device, a first delay associated with processing the response acknowledgment at the PPP device, and a second delay associated with opening the receive portion of link at the PPP device.

20. The apparatus of claim 15, wherein to delay transmission of data from the MPSM to the PPP device comprises the PPP device to send another acknowledgement after the elapsed selected time period to the MPSM to indicate the transmit portion and receive portion of the link at the PPP device is open.

21. The apparatus of claim 15, wherein the MPSM and the PPP device support multi-link PPP (MLPPP).

22. The apparatus of claim 15, wherein the PPP link between the MPSM and the PPP device is a link control protocol (LCP) link.

23. The apparatus of claim 15, wherein the PPP link between the MPSM and the PPP device is a multiplexed network control program (NCPMUX) link.

24. An apparatus to manage point-to-point protocol (PPP) links between a MPSM (multi-protocol service module) and a PPP device, the apparatus comprising the MPSM when closing a link to:
close a transmit portion of the link at the MPSM and send a terminate request to the PPP device;
receive a terminate acknowledgement from the PPP device to indicate the PPP device transmit portion of the link is closed; and
to close the receive portion of the link at the MPSM after the receipt of the terminate acknowledgement.

25. The apparatus of claim 24, wherein after the MPSM to receive the terminate acknowledgement from the PPP device, the PPP device to close the receive portion of its link.

26. The apparatus of claim 24, wherein the MPSM and the PPP device support multi-link PPP (MLPPP).

27. The apparatus of claim 24, wherein the PPP link between the MPSM and the PPP device is a link control protocol (LCP) link.

28. The apparatus of claim 24, wherein the PPP link between the MPSM and the PPP device is a multiplexed network control program (NCPMUX) link.

29. A machine-readable medium embodying instructions which, when executed by a machine, cause the machine to perform a method to manage point-to-point protocol (PPP) links between a MPSM (multi-protocol service module) and a PPP device, the method comprising:
when opening a link,
receiving an acknowledgement at the first endpoint from the second endpoint;
opening the receive portion of the link at the first endpoint;
sending a response acknowledgement from the first endpoint to the second endpoint; and
delaying transmission of data from the first endpoint to the second endpoint for a selected time period after the response acknowledgement has been sent.

30. A machine-readable medium embodying instructions which, when executed by a machine, cause the machine to perform a method to manage point-to-point protocol (PPP) links between a MPSM (multi-protocol service module) and a PPP device, the method comprising:
when closing a link,
closing the transmit portion of the link at the first endpoint and sending a terminate request to the second endpoint;
receiving a terminate acknowledgement from the second endpoint to indicate the second endpoint transmit portion of the link is closed; and
closing the receive portion of the link at the first endpoint after the receipt of the terminate acknowledgement.

31. An apparatus to manage point-to-point protocol (PPP) links between a MPSM (multi-protocol service module) and a PPP device, the apparatus comprising:
when opening a link,
means for receiving an acknowledgement at the first endpoint from the second endpoint;
means for opening the receive portion of the link at the first endpoint;
means for sending a response acknowledgement from the first endpoint to the second endpoint; and
means for delaying transmission of data from the first endpoint to the second endpoint for a selected time period after the response acknowledgement has been sent.

32. An apparatus to manage point-to-point protocol (PPP) links between a MPSM (multi-protocol service module) and a PPP device, the apparatus comprising:
when closing a link,
means for closing the transmit portion of the link at the first endpoint and sending a terminate request to the second endpoint;
means for receiving a terminate acknowledgement from the second endpoint to indicate the second endpoint transmit portion of the link is closed; and
means for closing the receive portion of the link at the first endpoint after the receipt of the terminate acknowledgement.
